(19) United States
(12) Patent Application Publication
(10) Pub. No.: US 2007/0147327 A1
(43) Pub. Date: Jun. 28, 2007

(54) Method and apparatus for transferring non-speech data in voice channel

(75) Inventors: Xiaohui Jin, Shanghai (CN); Bo Liu, Shanghai (CN); Xiaoling Shao, Shanghai (CN); Lei Feng, Shanghai (CN); Yonggang Du, Shanghai (CN)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V., Eindhoven (NL)

(21) Appl. No.: 10/579,024

(22) PCT Filed: Nov. 5, 2004
(86) PCT No.: PCT/IB04/52319

§ 371 Date: May 10, 2006

(30) Foreign Application Priority Data
Nov. 12, 2003 (CN) 200310114288.7

(51) Int. Cl. H04B 7/216; H04J 1/02

(52) U.S. Cl. 370/342; 370/493

(57) ABSTRACT

A method is proposed for a mobile terminal in mobile communication systems to transfer non-speech data in voice channel, comprising steps of: encapsulating the non-speech data to be sent to another mobile terminal into IBD frames; storing said IBD frames in a buffer; detecting whether a speech burst sent to said another mobile terminal is over; checking whether there is non-speech data to be sent to said another mobile terminal if detecting that said speech burst is over; sending at least one non-speech data to said another mobile terminal via voice channel if there is non-speech data to be sent. By modifying the SID frame and silence speech frame, this method realizes transmission of non-speech via voice channel rather than via dedicated data channel, so as to save radio resources of the system.

### FIELD OF THE INVENTION

The present invention relates generally to a mobile communication method and apparatus, and more particularly, to a communication method and apparatus for transferring non-speech data over voice channel in cellular mobile telecommunication systems.

### BACKGROUND ART OF THE INVENTION

In current 2G/3G mobile communication systems, speech signals and non-speech data are transferred respectively, with speech signals via voice channel and non-speech data via dedicated data channel.

The processing flow chart of transferring speech signals between two existing GSM mobile terminals is shown in FIG. 1. As illustrated in the figure, before being transmitted to the network system, the speech signal to be transmitted at the mobile terminal as sender side, is analog-to-digital converted by ADC 10, speech -compressed by speech compression unit 20, channel-coded by channel coding unit 30 and modulated by modulation & Tx unit 40 in Tx RSS (Transmitter Radio SubSystem) 93. While at the mobile terminal as receiver side, the received speech signal from the network system is demodulated by Rx & demodulation unit 50 and channel-decoded by channel decoding unit 60 in Rx RSS (Receiver Radio SubSystem) 96, then speech-decompressed by speech decompression unit 70, and digital-to-analog converted by DAC 80. Thus, at last, the original speech signal transmitted by the mobile terminal as sender side is recovered after the aforementioned processing steps.

Generally speaking, in a common dialog procedure, the behavior of either side of the communication includes two states: speaking and non-speaking. Based on this fact, a mobile terminal will transmitted the signal discontinuously in GSM mobile communication system. In another word, besides transmitting speech signals containing speech information, the mobile terminal also selectively transmits signals only containing background noise without speech information, to reduce signal interference and save energy. (That means the mobile terminal selectively transmits signals only containing background noise without speech information, besides transmits speech signals containing speech information normally, so as to reduce signal interference and save energy.). To implement discontinuous transmission mechanism in a mobile terminal, GSM mobile communication system uses a discontinuous transmission handler at the transmitter side (abbr. as Tx DTX handler later) in speech compression unit 20 to achieve discontinuous speech transmission, and a discontinuous transmission handler at the receiver side (abbr. as Rx DTX Handler) in speech decompression unit 70 to achieve discontinuous speech receiving.

FIG. 2 is a block diagram illustrating current speech processing unit used in GSM full-rate speech traffic. The speech processing unit comprises the functional block of speech compression unit 20 used for transmitting data, as well as the functional block of speech decompression unit 70 used for receiving data. Additionally, ADC 10, Tx RSS 93, Rx RSS 96 and DAC 80 are all included in FIG. 2 as well, to describe the complete procedure for transmitting/receiving speech signal.

As illustrated in FIG. 2, Tx DTX handler 90 for transmitting data comprises: speech encoder 901 (defined in GSM 06.10 standard), Tx DTX control & operation unit 902 (defined in GSM 06.31 standard), VAD (voice activity detector) 903 (defined in GSM 06.32 standard) and Tx comfort noise unit 904 (defined in GSM 06.12 standard). Meanwhile, Rx DTX handler unit 100 for receiving data comprises: Rx DTX control & operation unit 1001 (defined in GSM 06.31 standard), speech decoder 1002 (defined in GSM 06.10 standard), speech frame substitution unit 1003 (defined in GSM 06.11 standard) and Rx comfort noise unit 1004 (defined in GSM 06.12 standard).

A detailed description will be given below to the method for transmitting and receiving speech signal based on discontinuous transmission mechanism in GSM full-rate speech traffic, in conjunction with FIG. 2.

When a mobile terminal transmits speech signal, ADC 10 converts the analog speech signal to be transmitted into a 13-bit uniform PCM (Pulse Code Modulated) digital speech signal with 8000 samples per second, and delivers the digital speech signal to Tx DTX handler unit 90.

Speech encoder 901 in Tx DTX handler 90 receives the digital speech signal from ADC 10, and compresses the received signal into speech frames suitable for transmission over radio links (50 frames/second and 260 bit/frames for example), then sends the speech frames to Tx DTX control & operation unit 902. The speech frame including speech information from speech encoder 901 is 20 ms in duration. If the speech frame only has background noise included, without speech information, the frame is called as silence speech frame.

VAD 903 detects the digital speech signal from ADC 10 to determine whether the speech frame contains speech information. If speech information is contained, the VAD flag is set to 1; if the frame only contains background noise without speech information, the VAD flag is set to 0.

Tx comfort noise unit 904 detects the speech frame from speech encoder 901. If N consecutive silence speech frames are detected, the background noises embedded in the N consecutive silence speech frames will be summed and averaged, to get the average background noise. Then, the background noise parameters can be computed from the average background noise and encoded into a special frame, i.e. the silence description frame (SID frame, with 260 bits/frame). Finally, the SID frame containing background noise parameters is transmitted to Tx DTX control & operation 902.

Wherein:

First, in Tx comfort noise unit 904, the number N of consecutive silence speech frames used for computing the average background noise, is called the number of silence speech frames for computing the SID frame. The value of N is 4 in GSM full-rate speech traffic while is 8 in GSM half-rate speech traffic.

Second, the silence speech frame generated in Tx comfort noise unit 904 is 20 ms in duration, and only contains the parameter for generating background noise in the mobile terminal as receiver, but without speech information.

Since the speech frame from speech encoder 901 has the same duration as the SID frame from Tx comfort noise unit 904, some specific bits in the frame can be defined as SID code word, to distinguish different types of frames. For the SID frame, its SID code word is all 0, while the SID code word is not all 0 for the speech frame. Therefore, a frame can be determined as speech frame o r SID frame by detecting the SID code, that is, by checking the value of said specific bits.

For example, in the GSM full-rate speech traffic as illustrated in FIG. 3, every 20 ms frame is composed of 260 bits, in which 36 bits are used for LAR (Log Area Ratios) and the other 224 bits for 4 sub-frames. Each sub-frame is composed of 56 bits, in which 7 bits are used for LTP (Long Term Prediction) lag parameter, 2 bits for LTP gain parameter, 2 bits for RPE (Regular Pulse Excitation) grid position parameter, 6 bits for Block Amplitude parameter and 39 bits for RPE-pulse X_{mc} parameter.

In FIG. 3, the 156-bit X mc parameters (39 bits/subframe*4 subframes=156 bits) is made up of RPE-pulse X_{mc} of each sub-frame, in which 95 bits of RPE-pulse X_{mc} drawn out from the total 156-bit X_{mc} parameter sets, are used as a SID code word and the remained 61 bits are reserved for future use. If the SID code word equals to zero, the frame is a SID frame, otherwise, it is a speech frame.

On receipt of speech frames from speech encoder 901 or SID frames from Tx comfort noise unit 904, Tx DTX control & operation unit 902 checks the state of the VAD flag. If the VAD flag is 1, Tx DTX control & operation unit 902 sets the SP (speech period) flag to 1 and sends the speech frame from speech encoder 901 to Tx RSS 93. If VAD changes to 0 from 1, it indicates that the speech burst is over, then Tx DTX control & operation unit 902 checks N_{elapsed}, which is the number of speech frames sent to Tx RSS 93 since the latest SID frame update, to determine whether the hangover procedure needs to be enabled.

Herein, hangover procedure is a mandatory mechanism for updating SID frame. Without the hangover procedure, after sending a speech burst, a mobile terminal then sends a SID frame generated before said speech burst. There will be no problem if the speech burst is very short. But if the speech burst is very long, the background noise embedded in the SID frame generated before this long speech burst, may be significantly different from that generated when the speech burst ends. If the mobile terminal as receiver generates background noise by using the SID frame generated before the long speech burst, mismatching background noise will be produced, and it can be very uncomfortable for the mobile terminal as receiver. In order to overcome this deficiency, a mobile terminal first sends N silence speech frames to the mobile terminal as receiver after the long speech burst, and then sends a new SID frame containing the latest background noise parameters generated according to these silence speech frames.

Descriptions will be given below to the operations of DTX handler unit 90, with regard to enabling hangover procedure and not enabling hangover procedure respectively, in conjunction with FIG. 4 and FIG. 5.

1. Not enabling hangover procedure, wherein N_{elapsed}, the number of speech frames sent out, is not more than the predefined number of speech frames required for enabling hangover procedure.

Tx DTX control & operation unit 902 won't enable a hangover procedure, and sets the SP flag to 0, and then forwards the SID frame from Tx comfort noise unit 904 to Rx RSS 93.

FIG. 4 is a schematic diagram illustrating the discontinuous transmission mechanism in current GSM full-rate speech traffic when hangover procedure is not enabled. As the figure illustrates, VAD 903 detects there is some speech information in the speech signal during the speech burst, and thus sets the VAD flag to 1; when the speech burst is over, no speech information can be detected, thus VAD 903 sets the VAD flag to 0. When the VAD flag is 1, Tx DTX control & operation unit 902 sets the SP flag to 1, and forwards the speech frames from speech encoder 901 to Tx RSS 93. When the VAD flag changes from 1 to 0, Tx DTX control & operation unit 902 checks N_{elapsed}, the number of speech frames sent to the Tx RSS since the last SID frame update, and finds N_{elapsed}=22. This means it is not more than the predefined threshold of the hangover procedure, and thus the hangover procedure needn't be enabled. Therefore, Tx DTX control & operation unit 902 sets the SP flag to 0, and forwards the SID frame from Tx comfort noise unit 904 to Tx RSS 93. Wherein, the number of silence speech frames used for computing the SID frame is 4, so Tx comfort noise unit 904 generates a new SID frame after detecting 4 consecutive silence speech frames, hence the first 4 SID frames (for example, SIDₖ as shown in the figure) sent to Tx RSS 93 after the end of the speech burst are generated before the speech burst, and the fifth and consequent frames thereafter (for example, SIDₖ₊₁ as shown in the figure) are new SID frames generated after the speech burst.

2. Enabling hangover procedure, wherein N_{elapsed}, the number of speech frames sent out, is greater than the predefined number of speech frames required for enabling hangover procedure.

Tx DTX control & operation unit 902 enables the hangover procedure, that is, Tx DTX control & operation unit 902 first continues to set the SP flag to 1, and forwards the consecutive silence speech frames from speech encoder 901, having the same number as the silence speech frames used for computing the SID frame, to Tx RSS 93. Then, the SP flag is set to 0, and the new SID frame from Tx comfort noise unit 904 and generated according to said silence speech frames, is sent to Tx RSS 93.

FIG. 5 is a schematic diagram illustrating the discontinuous transmission mechanism in current GSM full-rate speech traffic when the hangover procedure is enabled. As illustrated in the figure, VAD 903 detects that there is some speech information contained in the speech signal during the speech burst, and sets the VAD flag to 1; when the speech burst is over, VAD 903 detects there is no speech information contained in the speech signal, so VAD 903 sets the VAD flag to 0. When the VAD flag is 1, Tx DTX control & operation unit 902 sets the SP flag to 1, and forwards the speech frames from speech encoder 901 to Tx RSS 93. When the VAD flag changes from 1 to 0, Tx DTX control & operation unit 902 checks N_{elapsed}, the number of speech frames sent to Tx RSS 93 since the last SID frame update, and finds N_{elapsed}=50, greater than predefined threshold for hangover procedure, thus the hangover procedure is enabled. That means, the SP flag is set to 1 first, and 4 consecutive silence speech frames from speech encoder 901 are sent to Tx RSS 93. Then, the SP flag is set to 0, and the new SID frame (for example, SIDₖ₊₁ as shown in the figure) from Tx comfort noise unit 904 and generated according to said 4 silence speech frames, is sent to Tx RSS 93.

On receipt of the frames from Tx DTX control & operation unit 902, Tx RSS 93 checks the state of the SP flag. If the flag SP is detected to be 1, it will forward the frame from Tx DTX control & operation unit 902 to a mobile terminal as receiver. If the SP flag is found to be 0, the SID code word of the frame from Tx DTX control & operation unit 902 will be checked. If the SID code word equals to 0, that is, the frame is a SID frame, it will send the frame to the network system and switches to idle state.

Rx RSS 96 in the mobile terminal as receiver receives frames transmitted from the mobile terminal as sender via the network system, and forwards the received frame to Rx DTX control & operation unit 1001, and sets the BFI (bad frame indicator) flag, SID flag and TAF (time alignment flag) flag meanwhile:
(1) if the received frame is a perfect speech frame, set BFI=0 and SID=0;
(2) if the received frame is a bad speech frame, set BFI=1 and SID=0;
(3) if the received frame is a perfect SID frame, set BFI=0 and SID=2, and mark the position of the SID frame in the multiple SACCH (slow associated control channel) frames in the TAF flag;
(4) if the received frame is a bad SID frame, set BFI=1 and SID=1.

On receipt of frames from Rx RSS 96, Rx DTX control & operation unit 1001 performs relevant processing on the received frame according to the states of BFI, SID and TAF:

(1) if BFI=0 and SID=0, it indicates that the received frame is a perfect speech frame, thus the perfect speech frame will be sent to speech decoder 1002;

(2) if BFI=1 and SID=0, it indicates that the received frame is bad speech frame, speech frame substitution unit 1003 will be instructed to generate a perfect speech frame;

(3) if BFI=0 and SID=2, it indicates that the received frame is a perfect SID frame, the perfect SID frame will be sent to Rx comfort noise unit 1004;

(4) if BFI=1 and SID=1, it indicates that the received frame is a bad SID frame, speech frame substitution unit 1003 will be instructed to compute the background noise parameters.

Speech decoder 1002 receives perfect speech frames from Rx DTX control & operation unit 1001, then gets digital speech signals by speech decoding the perfect speech frames, and sends the digital speech signals to DAC 80.

Rx comfort noise unit 1004 receives the perfect SID frames from Rx DTX control & operation unit 1001, then extracts background noise parameters from the perfect SID frames and sends the parameters to speech decoder 1002 to generate background noise.

Speech frame substitution unit 1003 generates perfect speech frames or computes background noise parameters according to the instructions of Rx DTX control & operation unit 1001, and then sends the generated speech frames or background noise parameters to speech decoder 1002.

DAC 80 receives the digital speech signal from speech decoder 1002, then converts the digital speech signal into analog speech signal and sends it to the corresponding processing unit.

Detailed descriptions have been offered to the transmission and receiving of speech signals based on discontinuous transmission mechanism in GSM communication system, in conjunction with FIG. 2, FIG. 3 and FIG. 4.

Just as stated, when the speech burst is over, the Tx DTX control & operation unit sends SID frames, or silence speech frames and SID frames to the Tx RSS. Since there is no speech information in SID frames and silence speech frames, if data frames containing non-speech data rather than silence speech frames or SID frames are sent when silence speech frames or SID frames are supposed to be sent, non-speech data can be sent via voice channel without affecting the delivery of speech information. Thus, no dedicated data channel is needed for the delivery of non-speech data, which will significantly save radio resources for communication and eliminate the time for establishing dedicated data channels.

### SUMMARY OF THE INVENTION

The object of present invention is to provide a method and apparatus for transferring non-speech data over voice channel in mobile communication systems. In the proposed method and apparatus, non-speech data can be transferred via voice channel, instead of dedicated data channel, through modifying the SID frame or silence speech frame, and thus the radio resource can be greatly saved.

A method is proposed for a mobile terminal to transmit non-speech data via voice channel in mobile communication systems in accordance with the present invention, comprising: encapsulating the non-speech data to be transmitted into in-band data (IBD) frames; storing the IBD frames in a buffer; detecting whether the speech burst sent to another mobile terminal is over; checking whether there is any non-speech data to be sent to said another mobile terminal if the speech burst is over; sending at least one non-speech data frame to said another mobile terminal via voice channel, if there is non-speech data to be sent.

A method is proposed for a mobile terminal to transmit non-speech data via voice channel in accordance with the present invention, comprising: detecting the frame received from another mobile terminal; if the received frame is an in-band data (IBD) frame, storing the IBD frame in a buffer; generating background noise by taking advantage of the previously received SID frames.

IBD frames generated in accordance with the present invention, can be classified into three types: (1) the IBD code word for marking the IBD frame is composed of the SID code word for marking the SID frame, and the value of each bit selected from the bits that form the SID code word, for differentiating the IBD code word from the SID code word, can't be the same as that of each bit for marking the SID code word; (2) the IBD code word for marking the IBD frame is composed of all bits for carrying Block Amplitude parameter and at least one bit selected from the SID cod e word for marking the SID frame, and the value of each bit for carrying Block Amplitude parameter is zero, and the value of each bit selected from the SID code word can't be the same as that of each bit for marking the SID code word; (3) the IBD code word for marking the IBD frame is composed of the SID code word for marking the SID frame and at least one reserved bit not included in the SID code word.

### BRIEF DESCRIPTION OF THE ACCOMPANYING DRAWINGS

FIG. 1 is a schematic diagram illustrating speech signal transmission between two current GSM mobile terminals;

FIG. 2 is a block diagram illustrating current speech processing unit used in GSM full-rate speech traffic;

FIG. 3 is a schematic diagram illustrating current speech frame used in GSM full-rate speech traffic;

FIG. 4 is a schematic diagram illustrating the current discontinuous transmission mechanism in GSM full-rate speech traffic when the hangover procedure is not enabled;

FIG. 5 is a schematic diagram illustrating the discontinuous transmission mechanism in GSM full-rate speech traffic when the hangover procedure is enabled;

FIG. 6 is a schematic diagram illustrating an embodiment of the first type of IBD frame in the present invention;

FIG. 7 is a schematic diagram illustrating an embodiment of the second type of IBD frame in the present invention;

FIG. 8 is a schematic diagram illustrating an embodiment of the third type of IBD frame in the present invention;

FIG. 9 is a block diagram illustrating the speech processing unit used in GSM full-rate speech traffic in accordance with the present invention;

FIG. 10A and FIG. 10B are flow charts illustrating the transmission of the first type of IBD frames in accordance with the present invention when the hangover procedure is not enabled;

FIG. 11A and FIG. 11B are flow charts illustrating the transmission of the second type of IBD frames in accordance with the present invention when the hangover procedure is not enabled;

FIG. 12A and FIG. 12B are flow charts illustrating the transmission of the third type of IBD frames in accordance with the present invention when the hangover procedure is not enabled;

FIG. 13 illustrates an embodiment of transmitting the first (second) type of IBD frames in the present invention when the hangover procedure is not enabled;

FIG. 14 illustrates an embodiment of transmitting the third type of IBD frames in the present invention when the hangover procedure is not enabled;

FIG. 15A and FIG. 15B are flow charts illustrating the transmission of the first type of IBD frames in accordance with the present invention when the hangover procedure is enabled;

FIG. 16A and FIG. 16B are flow charts illustrating the transmission of the second type of IBD frames in accordance with the present invention when the hangover procedure is enabled;

FIG. 17A and FIG. 17B are flow charts illustrating the transmission of the third type of IBD frames in accordance with the present invention when the hangover procedure is enabled;

FIG. 18 illustrates an embodiment of transmitting the first (second, third) type of IBD frames in the present invention when the hangover procedure is enabled.

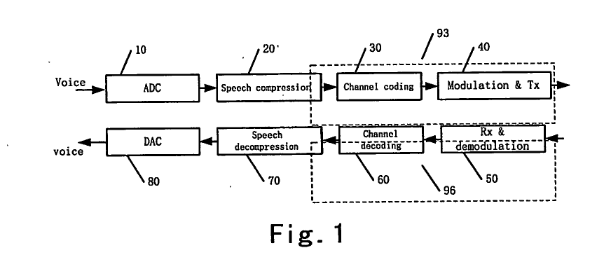

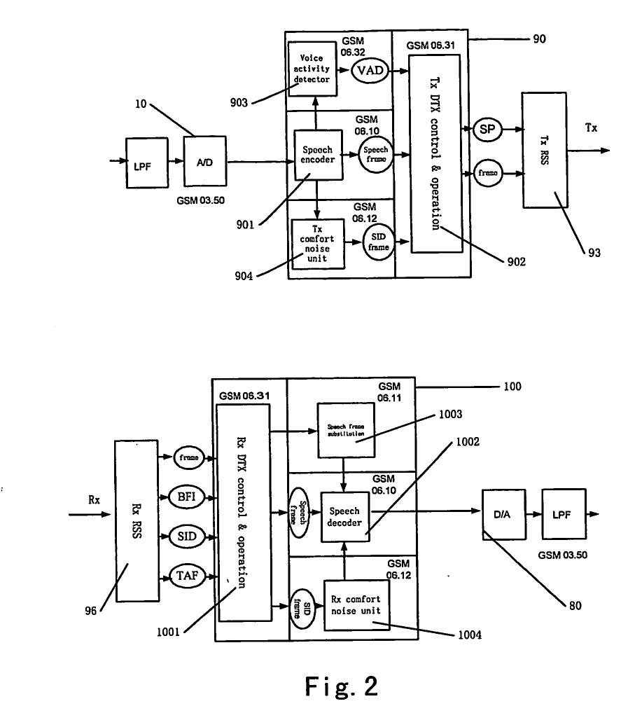

### DETAILED DESCRIPTION OF THE INVENTION

In the present invention, non-speech data transferred via voice channel instead of dedicated data channel, is called as IBD (In-Band Data). A method is proposed for transferring IBD via voice channel, focusing on constructing three types of IBD frames for transferring non-speech data, based on conventional frames in mobile communication services. The three frames have different structures from the speech frames and SID frames in current speech traffic, but of the same length. Thus, transmission of non-speech data can be realized without making significant modifications to the hardware equipments of current network system and mobile terminal hardware in mobile communication.

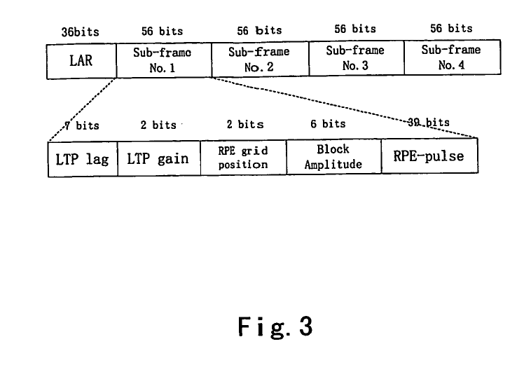

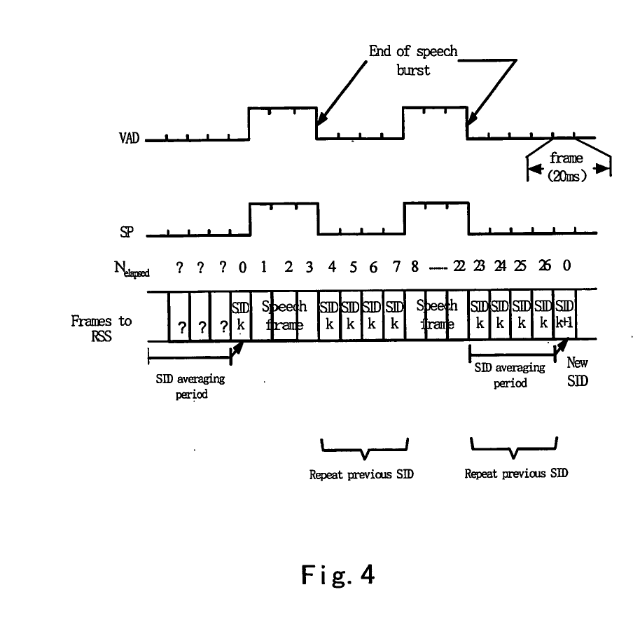

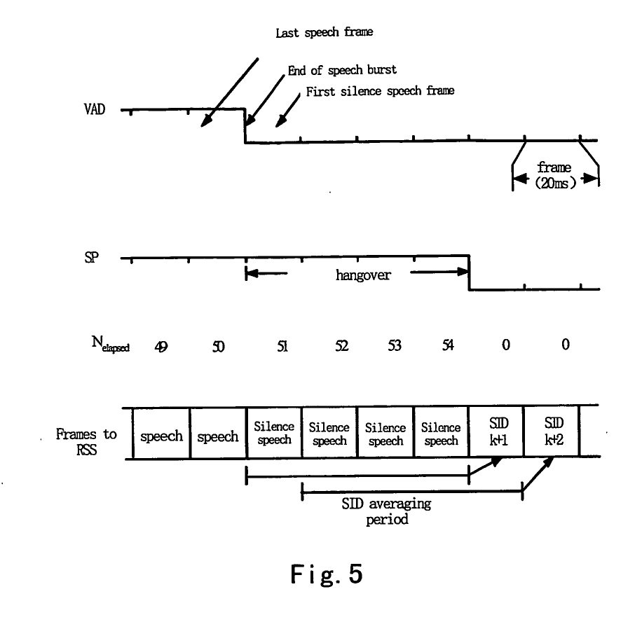

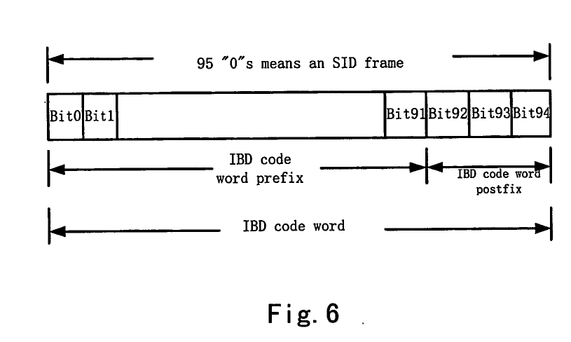

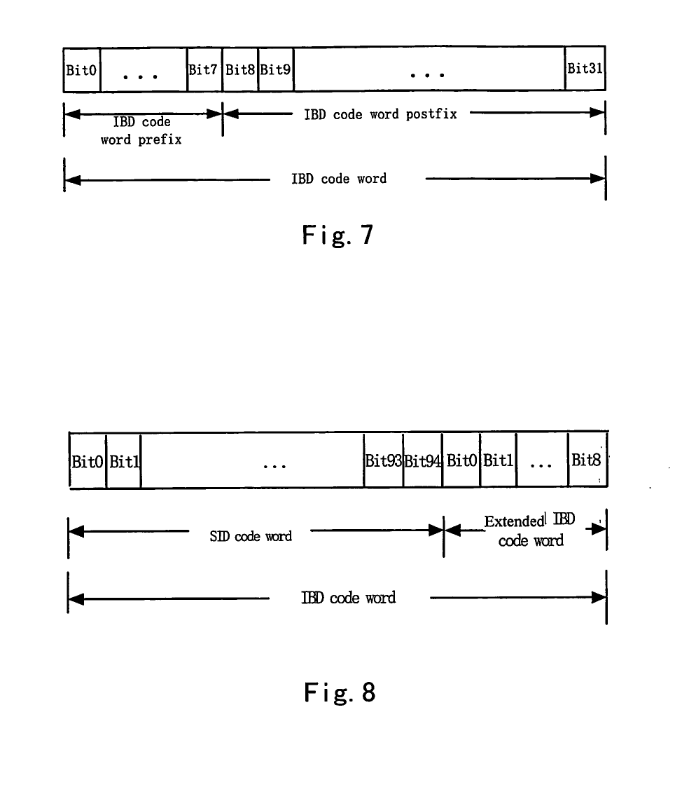

GSM full-rate speech traffic will be exemplified below, to elaborate the three types of IBD frames constructed based on the frame structure as illustrated in FIG. 3, in connection with FIG. 6, FIG. 7 and FIG. 8.

1. The First Type of IBD Frame

The first type of IBD frame is marked by the 95 bits of the SID code word. In the 95 bits, M bits are defined as the IBD code word postfix and the remained (95−M) bits are defined as the IBD code word prefix. That is:
IBD code word=IBD code word prefix+IBD code word postfix

In the IBD code word, all the (95−M) bits as the prefix are zero, but the M bits as the postfix can't be zero at the same time. The IBD code word constructed in this way occupies the same bits as the SID code word, but the two types of code words can be differentiated according to whether the IBD code word postfix is zero or not. That is to say, the proposed method identifies a received frame as speech frame, SID frame or data frame, only through checking the 95-bit IBD code word in this frame. If the value of the IBD code word is zero, i.e. the prefix and postfix of the IBD code are both zero, the frame is a SID frame; if the value of the IBD code word is not zero and the IBD code word prefix is not zero, the frame is a speech frame; only when the IBD code word is not zero and the prefix of the IBD frame word is zero while the postfix is not zero, the frame is an IBD frame.

Since construction of the IBD frame has occupied M bits of the 95 bits for marking the SID frame in current frame, in order to transfer non-speech data using the first type of IBD frame, it must be guaranteed that normal speech information is included in the speech frame generated by the speech encoder, and the probability of the (95−M) bits all being zero is equal to the probability of the 95 bits all being zero. In other words, it should be guaranteed during communication that the probability of the (95−M) bits being used for speech frame is equal to the probability of the 95 bits being used for speech frame, that is, the frame consisting of the (95−M) bits of zero value and M bits of non-zero, can only be an IBD frame rather than a speech frame in the present invention. As long as the value of M is chosen carefully, i.e., not too large, this condition can be satisfied easily.

FIG. 6 illustrates an embodiment of the above first type of IBD code word. In this embodiment, 3 bits out of the 95 bits are taken out to mark the IBD frame, that is M=3 (as to which 3 bits are selected, it is to be decided according to the speech encoder). As shown in the figure, it's assumed that bit 0 to bit 91 are defined as the IBD code word prefix while bit 92 to bit 94 as the IBD code word postfix. Depending on the value of bits 92,93 and 94, at most 7 kinds of the first type of IBD frames can be defined in the embodiment shown in FIG. 6. For example, we can define the IBD request frame as the one whose bits 92,93 and 94 are 0, 0 and 1 respectively, i.e. the one whose IBD code word prefix equals to 0 and IBD code word postfix equals to 1; and the IBD response frame as the one whose bits 92,93 and 94 are 0, 1 and 0 respectively, i.e. the one whose IBD code word prefix equals to 0 and IBD code word postfix equals to 2.

As illustrated above, transmission of non-speech data via voice channel can be realized by exploiting the first type of IBD frame without affecting current speech communication services, through redefining the bits in current SID code word.

2. The Second Type of IBD Frame

As illustrated in the above description with FIG. 3, there is the 6-bit Block Amplitude parameter for denoting the amplitude of the speech signal in every sub-frame of a frame. No matter in speech frame or SID frame, the Block Amplitude parameter of the frame, constructed by Block Amplitude parameters of 4 sub-frames (totally 24 bits), should not be all zero.

The second type of In-Band Data frame, or namely the second type of IBD frame, can be identified by the above Block Amplitude parameter. Specifically, if the Block Amplitude parameter of a frame is zero, the frame is the second type of IBD frame; otherwise, the frame is speech frame or SID frame.

But in this way, only one kind of the second type of IBD frame can be defined at the data link layer. If the second type of IBD frames of different meanings are required to be transferred, further settings need to be made.

In a speech traffic, regarding a frame constructed by 260 bits, if the 156 bits of the SID code word and the 24 bits of the Block Amplitude parameter are both zero simultaneously, the mobile terminal as receiver will regard this frame as a SID frame and provides it to the Rx comfort noise unit to generate background noise, because the SID code word is zero. Meanwhile, the Block Amplitude parameter is zero, thus this may result in sharp change in the background noise at the mobile terminal as receiver. Therefore, the SID code word and Block Amplitude parameter can't be both zero simultaneously in a frame. According to this specification, in upper-layer protocols, some bits in the SID code word can be used to identify the second type of IBD frames of different meanings, along with the above Block Amplitude parameter.

According to the proposed second type of IBD frame, the Block Amplitude parameter of 24 bits is defined as the IBD code word postfix, and the bits drawn out of the SID code word for marking IBD frames of different meanings, are defined as the IBD code word prefix. That is:
IBD code word=IBD code word prefix+IBD code word postfix

Herein, the 24 bits as the IBD code word postfix are zero, while each bit in the prefix can't be zero simultaneously. The IBD code word constructed in this way can differentiate SID frame, speech frame and IBD frame distinctly, as well as implement transmission of IBD frames with different meanings via voice channel, through combining some bits in the SID code word with the Block Amplitude parameter.

FIG. 7 illustrates an embodiment of the above second type of IBD code word. In this embodiment, 8 bits are drawn out of the SID code word to construct the prefix of the second type of IBD code word. As shown in the figure, it's assumed that bit 0 to bit 7 are defined as the IBD code word prefix while bit 8 to bit 31 are defined as the IBD code word postfix. Since the value of bit 8 to bit 31 is zero, at most 255 kinds of the second type of IBD frames can be defined in the embodiment of FIG. 7, according to the value of bit 0 to bit 7. For example, the IBD request frame can be defined as the one whose IBD code word prefix equals to 1 and postfix equals to 0, while the IBD response frame can be defined as the one whose IBD code word prefix equals to 2 and postfix equals to 0.

As illustrated above, transmission of non-speech data via voice channel can be realized by using the proposed second type of IBD frame, through setting the Block Amplitude parameter to zero and in combination with some bits in current SID code word. And furthermore, current speech communication services won't be affected.

3. The Third Type of IBD Frame

The third type of In-Band data frame, or namely the third type of IBD frame, is composed of the 95 bits in SID code word and some reserved bits. The reserved bits are called as extended IBD code word, and they can be the bits reserved but not used yet in the SID frame. For example, in GSM full-rate speech traffic, the SID code word only occupies 95 bits of the 156-bit X_{mc} and the remained 61 bits are reserved for future use. The third type of IBD frame can be identified through using some of the reserved bits as the extended IBD code word. That is:
IBD code word=SID code word+extended IBD word

FIG. 8 illustrates an embodiment of the above third type of IBD code word. In this embodiment, the extended IBD code word is defined as the first bits of the 68^{th} parameter to the 76^{th} parameter in X_{mc} (totally 9 bits). According to the 9 bits from Bit 0 to Bit 8, the IBD code word in FIG. 8 can define (2⁹−1=511) kinds of the third type of IBD frames at most. For example, the IBD request frame can be defined as the one whose extended IBD code word equals to 1 and SID code word equals to 0, while the IBD response frame can be defined as the one whose extended IBD code word equals to 2 and SID code word equals to 0.

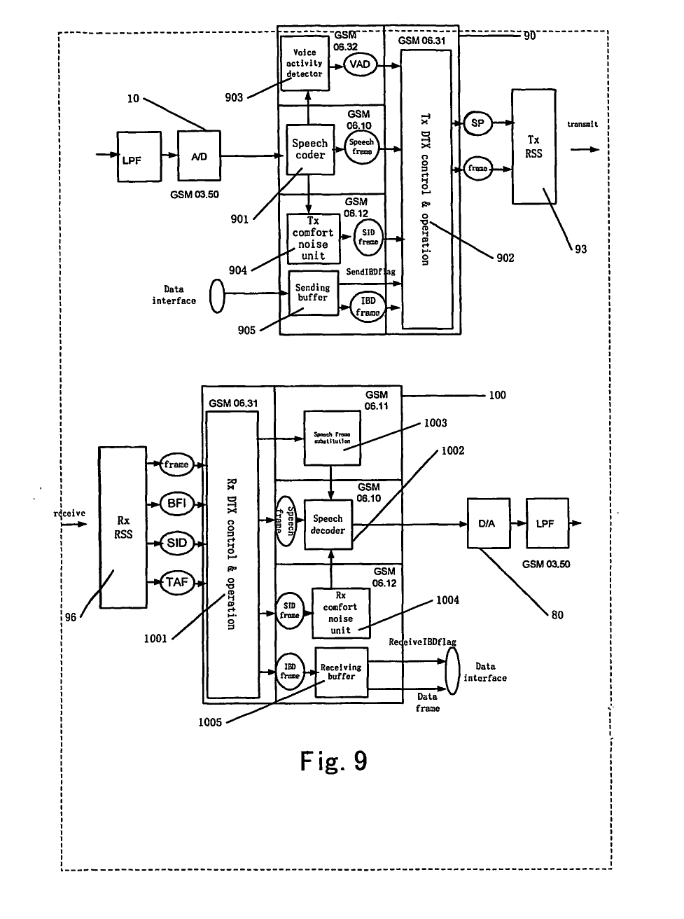

The three types of the proposed IBD frames are described above in detail in conjunction with FIG. 6 to FIG. 8. To implement transmission of the three types of IBD frames via voice channel, some modifications have to be made to the speech processing unit of current mobile terminals. The modified speech processing unit will be elaborated below, in conjunction with FIG. 9.

(1) In Tx DTX Handler Unit 90, a sending buffer 905 is added for storing the IBD frames to be transmitted, and a sending IBD flag SendIBDFlag is also added for indicating whether there are IBD frames stored in sending buffer 905. In this way, when upper-layer applications have some non-speech data to be transmitted, the mobile terminal encapsulates the non-speech data into IBD frames and stores them in sending buffer 905, and then sets SendIBDFlag to 1, to notify Tx DTX control & operation unit 902 that there are some frames to be transmitted in sending buffer 905. After Tx DTX control & operation unit 902 sends all IBD frames stored in sending buffer 905 to Rx RSS 93, the mobile terminal sets SendIBDFlag to 0, to notify Tx DTX control & operation unit 902 that sending buffer 905 is empty.

(2) In Rx DTX handler unit 100, a receiving buffer 1005 is added for storing the received IBD frames, and a receiving IBD flag Receive IBDFlag is also added for indicating whether there are IBD frames stored in receiving buffer 1005. In this way, when Rx DTX Control and Handle Unit 1001 receives IBD frames, the mobile terminal stores the IBD frames in receiving buffer 1005, and meanwhile sets Receive IBDFlag to 1, to notify upper-layer applications that there are IBD frames received in receiving buffer 1005. When upper-layer applications take out all the IBD frames stored in buffer 1005, the mobile terminal sets Receive IBDFlag to 0, to notify upper-layer applications that receiving buffer 1005 is empty.

(3) The queuing algorithm in Tx DTX control & operation unit 902 is modified, so that IBD frames can be sent to the Tx RSS.

(4) Rx DTX control & operation unit 1001 is modified to identify the received IBD frames.

(5) The upper-layer applications in the mobile terminal is provided with a data interface for reading or writing IBD frames, and thus upper-layer applications can write IBD frames into sending buffer 905 and read IBD frames from receiving buffer 1005 via the data interface.

As explained in the above modifications, besides the data interface, sending buffer 905, SendIBDFlag, receiving buffer 1005, and ReceiveIBDFlag are added herein, the present invention only recommends modifications to Tx DTX control & operation unit 902 and Rx DTX control & operation Unit 1001, without making modifications to speech encoder 901, VAD 903, Tx comfort noise unit 904, speech decoder 1002, speech frame substitution unit 1003, Rx comfort noise unit 1004, Tx RSS 93 and Rx RSS 96. Thus it can be seen herein that very little modifications are required to be made in current mobile terminals to implement the present invention.

In the following section, detailed descriptions will be given respectively to the transmission of the proposed first type of, second type of and third type of IBD frames via voice channel, exemplifying two modified mobile terminals supporting IBD frames in GSM full-rate speech traffic.

I. The Method for Transmitting Three Types of IBD Frames when the Hangover Procedure is not Enabled

(I) The Method for Transmitting the First Type of IBD Frame via Voice Channel when the Hangover Procedure is not Enabled

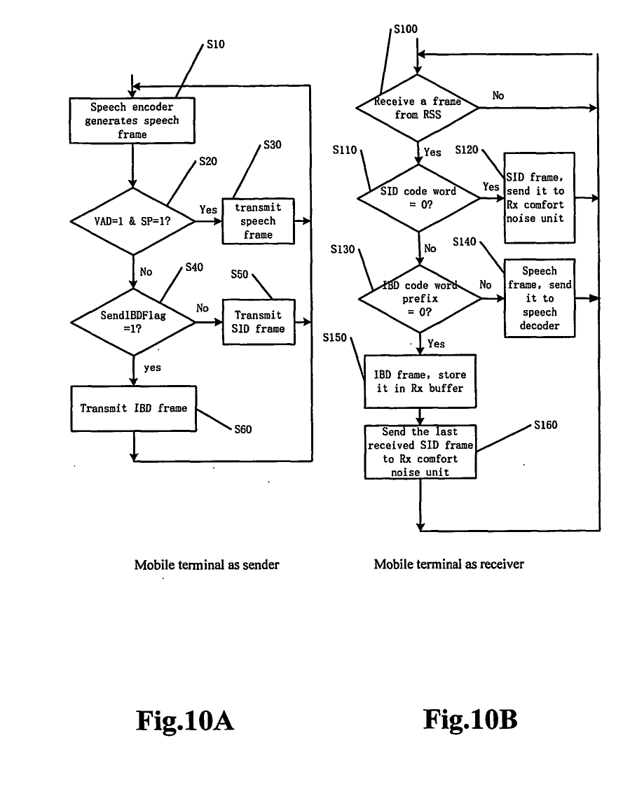

FIG. 10A and 10B are flow charts illustrating the transmission of the first type of IBD frames when the hangover procedure is not enabled, in accordance with the present invention.

As displayed in FIG. 10A, in the mobile terminal as sender, speech encoder 901 generates speech frames and sends them to Tx DTX control & operation unit 902 (step S10). On receipt of the speech frames from speech encoder 901, Tx DTX control & operation unit 902 checks the state of the VAD flag (step S20).

1. If the VAD flag is 1, Tx DTX control & operation unit 902 sets the SP flag to 1 and sends the speech frames from speech encoder 901 to Tx RSS 93, and then Tx RSS 93 forwards the received speech frames to the mobile terminal as receiver via the network system (step S30).

2. If the VAD flag changes from 1 to 0, that means the speech burst is over. If the hangover procedure needn't be enabled at this moment (that means N_{elapsed}, the number of speech frames sent to Tx RSS since the last SID frame updates, is not more than the predefined value), Tx DTX control & operation unit 902 sets the SP flag to 0 and checks the state of SendIBDFlag (step S40).

(1) If the SendIBDFlag is 0, that means sending buffer 905 is empty, then Tx DTX control & operation unit 902 sends SID frames to Tx RSS 93. After transmitting a received SID frame to the mobile terminal as receiver via the network system, Tx RSS 93 stops transmission and enters into idle state (step S50).

(2) If SendIBDFlag is 1, that means there are the first type of IBD frames to be transmitted in sending buffer 905, then Tx DTX control & operation unit 902 sends the IBD frames from sending buffer 905 to Tx RSS 93. (a) If the VAD flag is still zero after all IBD frames are sent out, then Tx DTX control & operation unit 902 sends SID frames to Tx RSS 93. After transmitting the received IBD frames and a SID frame to the mobile terminal as receiver via the network system, Tx RSS 93 stops transmission and enters into idle state. (b) If the VAD flag changes to 1 when the IBD frames are transmitted, it indicates there is new speech burst to be transferred, then Tx DTX control & operation unit 902 stops sending IBD frames but begins to send new speech frames of the speech burst, to the mobile terminal as receiver via the network system. Tx RSS 93 sends the received IBD frames and new speech frames of the speech burst to the mobile terminal as receiver. Since no SID frame is received, Tx RSS 93 will not stop transmission and switch into idle state (step S60).

As illustrated in FIG. 10B, in the mobile terminal as receiver, Rx RSS 96 checks whether it has received frames sent from the mobile terminal as sender via the network system (step S100). If any frame is received, it will be sent to Rx DTX control & operation unit 1001. On receipt of a frame from Rx RSS 96, Rx DTX control & operation unit 1001 checks whether the SID code word of the frame is zero (step S110).

1. If the SID code word is zero, it indicates the frame is a SID frame, then Rx DTX control & operation unit 1001 sends this frame to Rx comfort noise unit 1004 for processing, to generate background noise (step S120).

2. If the SID code word is not zero, Rx DTX control & operation unit 1001 checks whether each bit as the IBD code word prefix in the SID code word is zero (step S130). (1) If the IBD code word prefix is not zero, it indicates the frame is a speech frame, then Rx DTX control & operation unit 1001 sends the speech frame to speech decoder 1002, to generate speech signals (step S140). (2) If the IBD code word prefix is zero, it indicates the frame is an IBD frame, then Rx control & operation unit 1001 stores the IBD frame into receiving buffer 1005, and sets ReceiveIBDFlag to 1 to notify upper-layer applications that there are IBD frames received (step S150), and meanwhile sends one of the latest received SID frames to Rx comfort noise unit 1004 to generate background noise (step S160).

(II) The Method for Transmitting the Second Type of IBD Frames via Voice Channel when the Hangover Procedure is Not Enabled

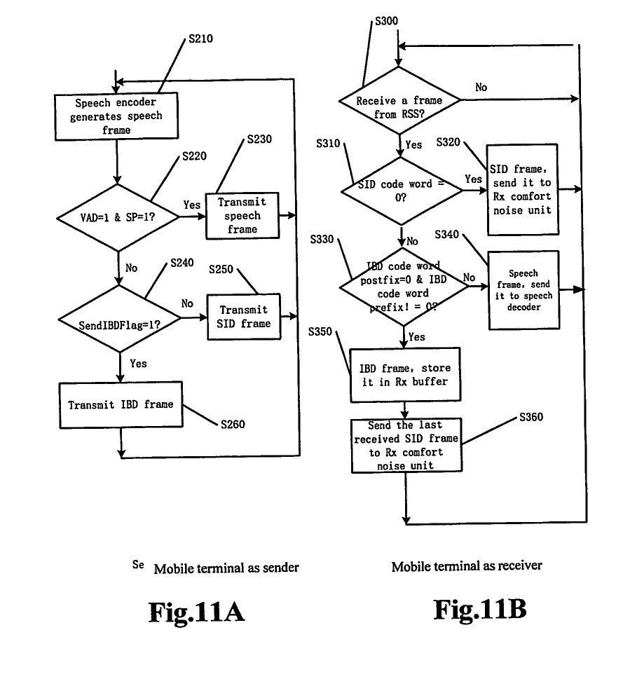

FIG. 11A and FIG. 11B are flow charts illustrating the transmission of the second type of IBD frames when the hangover procedure is not enabled in accordance with the present invention.

As FIG. 11A illustrates, in the mobile terminal as sender, speech encoder 901 generates speech frames and sends them to Tx DTX control & operation unit 902 (step S210). On receipt of the speech frames from speech encoder 901, Tx DTX control & operation unit 902 checks the state of the VAD flag (step S220).

1. If the VAD flag is 1, Tx DTX control & operation unit 902 sets the SP flag to 1 and sends the speech frames from speech encoder 901 to Tx RSS 93. Then Tx RSS 93 forwards the received speech frames to the mobile terminal as receiver via the network system (step S230).

2. If the VAD flag changes from 1 to 0, that means the speech burst is over. If the hangover procedure needn It be enabled at this moment (that is, N_{elapsed}, the number of speech frames sent to the Tx RSS since the latest SID frame updates, is not greater than the predefined value), Tx DTX control & operation unit 902 sets the SP flag to 0 and checks the state of SendIBDFlag (step S240).

(1) If SendIBDFlag is zero, it indicates sending buffer 905 is empty, then Tx DTX control & operation unit 902 sends SID frames to Tx RSS 93. After sending a received SID frame to the mobile terminal as sender via the network system, Tx RSS 93 stops transmission and switches to idle state (step S250).

(2) If the SendIBDFlag is 1, it indicates there are the second type of IBD frames to be sent in sending buffer 905, then Tx DTX control & operation unit 902 forwards the IBD frames stored in sending buffer 905 to Tx RSS 93. (a) If the VAD flag is still zero after all IBD frames in sending buffer 905 are sent out, Tx DTX control & operation unit 902 then sends SID frames to Tx RSS 93. After sending the received IBD frames and a SID frame to the mobile terminal as receiver, Tx RSS 93 stops transmission and switches to idle state. (b) If the VAD flag changes to 1 during IBD frame transmission procedure, it indicates there is new speech burst to be transferred, then Tx DTX control & operation unit 902 stops sending IBD frames but begins to send the speech frames of the new speech burst to Tx RSS 93. Tx RSS 93 sends the received IBD frames and the speech frames of the new speech burst to the mobile terminal as receiver. Since no SID frame is received, Tx RSS 93 will not stop transmission and switch to idle state (step S260).

As displayed in FIG. 11B, in the mobile terminal as receiver, Rx RSS 96 checks whether it has received frames sent from the mobile terminal as sender via the network system (step S300). If any frame has been received, it will be sent to Rx DTX control & operation unit 1001. On receipt of a frame from Rx RSS 96, Rx DTX control & operation unit 1001 checks whether the SID code word of the frame is zero (step S310).

1. If the SID code word equals to zero, it indicates that the frame is a SID frame, then Rx DTX control & operation unit 1001 sends the SID frame to Rx comfort noise unit 1004 for processing, to generate background noise (step S320).

2. If the SID code word is not zero, Rx DTX control & operation unit 1001 checks the value of each bit as the IBD code word in the frame, i.e. the value of the IBD code word prefix and that of the IBD code word postfix (step S330).

(1) If the IBD code word prefix is not zero and the postfix is zero, it indicates the frame is the second type of IBD frame, thus Rx DTX control & operation unit 1001 stores the IBD frame in receiving buffer 1005, and sets ReceiveIBDFlag to 1, to notify upper-layer applications that there are some IBD frames received (step S350). Then one of the latest received SID frames is sent to Rx comfort noise unit 1004 to generate the background noise (step S360).

(2) If the condition in (1) can't be satisfied, i.e. the IBD code word prefix is not zero and the postfix is zero, it indicates the frame is a speech frame. Rx DTX control & operation unit 1001 sends the speech frame to speech decoder 1002 to generate speech signals (step S340).

(III) The Method for Transmitting the Third Type of IBD Frames via Voice Channel when the Hangover Procedure is not Enabled

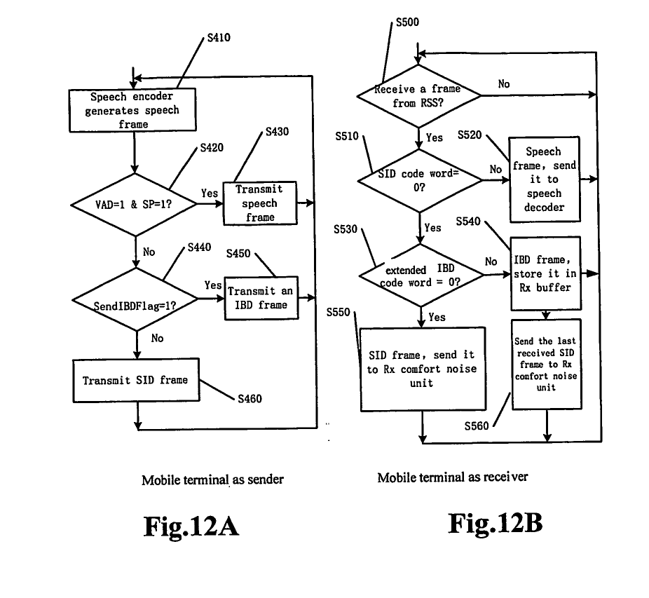

FIG. 12A and FIG. 12B are flow charts illustrating the transmission of the third type of IBD frames when the hangover procedure is not enabled.

As displayed in FIG. 12A, in the mobile terminal as sender, speech encoder 901 sends the generated speech frames to Tx DTX control & operation unit 902 (step S410). On receipt of the speech frames from speech encoder 901, Tx DTX control & operation unit 902 checks the state of the VAD flag (step S420).

1. If the VAD flag is found to be 1, Tx DTX control & operation unit 902 sets the SP flag to 1 and sends the speech frames from speech encoder 901 to Tx RSS 93, then Tx RSS 93 sends the received speech frames to the mobile terminal as receiver via the network system (step S430).

2. If the VAD flag changes from 1 to 0, it means the speech burst is over. If hangover procedure needn't be enabled at this moment (that is, N_{elapsed}, the number of speech frames sent to the Tx RSS since the latest SID frame updates, is not greater than the predefined value), Tx DTX control & operation unit 902 sets the SP flag to 0 and then checks the state of SendIBDFlag (step S440).

(1) If SendIBDFlag is 1, it indicates there are IBD frames to be transmitted in sending buffer 905, thus Tx DTX control & operation unit 902 sends one of the third type of IBD frames in sending buffer 905 to Tx RSS 93. The IBD word of the third type of IBD frame contains the SID code word and the value of the SID code word is zero, so Tx RSS 93 will stop transmission and switch to idle state after sending the IBD frame to the network system as a SID frame (step S450).

(2) If SendIBDFlag is 0, it indicates that sending buffer 905 is empty, thus Tx DTX control & operation unit 902 sends SID frames to Tx RSS 93. After sending the received SID frames to the mobile terminal as receiver via the network system, Tx RSS 93 stops transmission and switches to idle state (step S460).

As illustrated in FIG. 12B, in the mobile terminal as receiver, Rx RSS 96 checks whether it has received frames sent by the mobile terminal as sender (step S500). If any frame is received, it will be sent to Rx DTX control & operation unit 1001. On receipt of a frame from Rx RSS 96, Rx DTX control & operation unit 1001 checks whether the SID code word of the frame is zero (step S510).

1. If the SID code word is not zero, it indicates the frame is a speech frame, thus Rx DTX control & operation unit 1001 sends the speech frame to speech decoder 1002 for decoding (step S520).

2. If the SID code word is zero, Rx DTX control & operation unit 1001 checks whether the extended IBD code word in the frame is zero (step S530). (1) If the extended IBD code word is zero, it indicates the frame is a SID frame, then Rx DTX control & operation unit 1001 sends the SID frame to Rx comfort noise unit 1004 to generate background noise (step S550). (2) If the extended IBD code word is not zero, it indicates the frame is an IBD frame, thus Rx DTX control & operation unit 1001 stores the IBD frame in receiving buffer 1005 and sets ReceiveIBDFlag to 1, to notify upper-layer applications there are IBD frames received (step S540). Then, one of the latest received SID frames is sent to Rx comfort noise unit 1004 to generate background noise (step S560).

As illustrated in the above descriptions in connection with the flow charts in FIG. 10A and FIG. 10B, FIG. 11A and FIG. 11B, FIG. 12A and FIG. 12B, there are three differences among the transmission of the first type of, the second type of and the third type of IBD frames via voice channel when the hangover procedure is not enabled. (1) In the mobile terminal as sender, the three types of IBD frames are constructed differently, so the functional blocks in upper-layer applications for forming the three types of IBD frames should be different. Furthermore, the SID code word of zero value is included in the IBD code word of the third type of IBD frames, thus only one IBD frame can be transferred and the Tx RSS will be turned off every time the speech burst is over, if non-speech data are transferred by using the third type of IBD frames. Whereas several consecutive IBD frames can be transferred through adopting the first type of or the second type of IBD frames every time the speech burst is over, when the hangover procedure is not enabled. As long as no new speech burst is generated, all IBD frames to be transmitted can be sent out, and then a SID frame is sent for closing the Tx RSS. Except this, other functional blocks for transferring the three types of IBD frames are the same in the mobile terminal as sender. (2) In the mobile terminal as receiver, the three types of IBD frames are constructed differently, so the functional blocks in the Rx DTX control & operation unit for identifying the three types of IBD frames should be different too, and accordingly the functional blocks in upper-layer applications for decoding the three types of IBD frames should be of some difference. Except this, other functional blocks for processing the three types of IBD frames are the same in the mobile terminal as receiver.

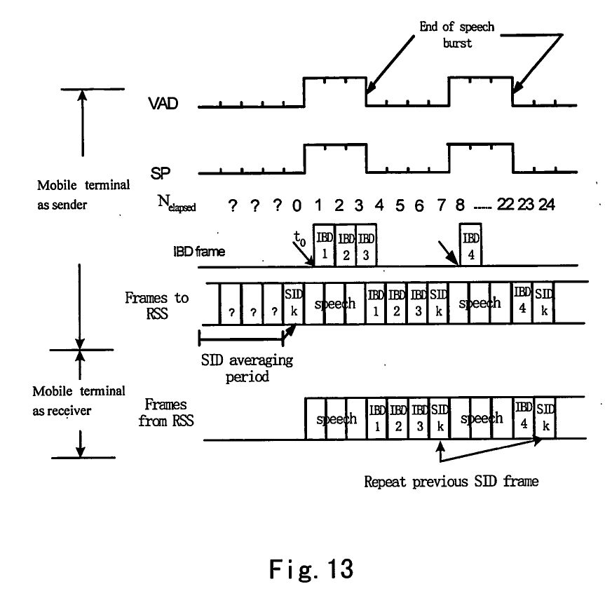

FIG. 13 illustrates an embodiment of the present invention, for transmitting the first type of IBD frames when the hangover procedure is not enabled, which is equally applicable to the transmission of the second type of IBD frames. As shown in the figure, the mobile terminal as sender sends two speech bursts, with the length of each speech burst as three speech frames.

As to the first speech burst, the VAD flag and SP flag are both 1 during the burst period, so Tx RSS 93 transmits the three speech frames of the speech burst to the mobile terminal as receiver via the network system. When the speech burst is over, i.e. the VAD flag changes from 1 to 0, N_{elapsed}, the number of speech frames sent to Tx RSS 93 since the latest SID frame updates, is not more than the predefined threshold of the hangover procedure, so Tx DTX control & operation unit 902 will not enable the hangover procedure and the SP flag is set to 0 meanwhile. At time t₀ during the first speech burst, the upper-layer application has stored three IBD frames (IBD1, IBD2 and IBD3) in sending buffer 905, so Tx DTX control & operation unit 902 first sends the IBD frames stored in sending buffer 905 to Tx RSS 93 when said speech burst is over. After the above three IBD frames are all sent out, the VAD flag is still 0, thus Tx DTX control & operation unit 902 continues to send SID frames to Tx RSS 93. After sending the received three IBD frames and one SID frame to the mobile terminal as receiver, Tx RSS 93 stops transmission and switches to idle state. In the mobile terminal as receiver, Rx RSS 96 correspondingly receives three speech frames, IBD1, IBD2, IBD3 and a SID frame sent from the mobile terminal as sender via the network system, and then sends them to Rx DTX control & operation unit 1001. First, Rx DTX control & operation unit 1001 sends the three received speech frames to speech decoder 1002 for decoding, according to the receiving sequence order. Then, Rx DTX control & operation unit 1001 stores IBD1, IBD2 and IBD3 in receiving buffer 1005, and sets the ReceiveIBDFlag to 1 to notify upper-layer applications there are some IBD frames received. Afterwards, the previously received SID frame is sent to Rx comfort noise unit 1004 three times to generate background noise (note that the three SID frames are the same). Finally, the received SID frame is sent to Rx comfort noise unit 1004 to generate background noise.

As to the second speech burst, the VAD flag and SP flag are both 1 during the burst period, thus Tx RSS 93 sends the three speech frames of the speech burst to the mobile terminal as receiver via the network system. When the speech burst is over, i.e. the VAD flag changes to 0, N_{elapsed}, the number of speech frames sent to Tx RSS 93 since the latest SID frame updates, is not greater than the threshold predefined by the hangover procedure, thus Tx DTX control & operation unit 902 will not enable the hangover procedure and set the SP flag to 0. At time t₁ during the speech burst, a frame IBD4 with respect to the second type of IBD frame is stored in sending buffer 905, so the Tx DTX control & operation unit 902 first sends IBD4 to Tx RSS 93 when the speech burst is over. After IBD4 is sent out, the VAD flag is still 0, so Tx DTX control & operation unit 902 continues to send SID frames to Tx RSS 93. After sending the received IBD4 and an SID frame to the mobile terminal as receiver via the network system, Tx RSS 93 stops transmission and switches to idle state. In the mobile terminal as receiver, Rx RSS 96 receives three speech frames of the speech burst, IBD4 and a SID frame from the mobile terminal as sender via the network system, and then hands them to Rx DTX control & operation unit 1001. According to the receiving order, Rx DTX control & operation unit 1001 first sends the three received speech frames to speech decoder 1002 for decoding; then stores IBD4 in receiving buffer 1005 and sets ReceiveIBDFlag to 1 to notify upper-layer applications that some IBD frames are received; afterward sends a previously received SID frame to Rx comfort noise unit 1004 to generate background noise; and finally, sends the received SID frame to Rx comfort noise unit 1004 to generate background noise.

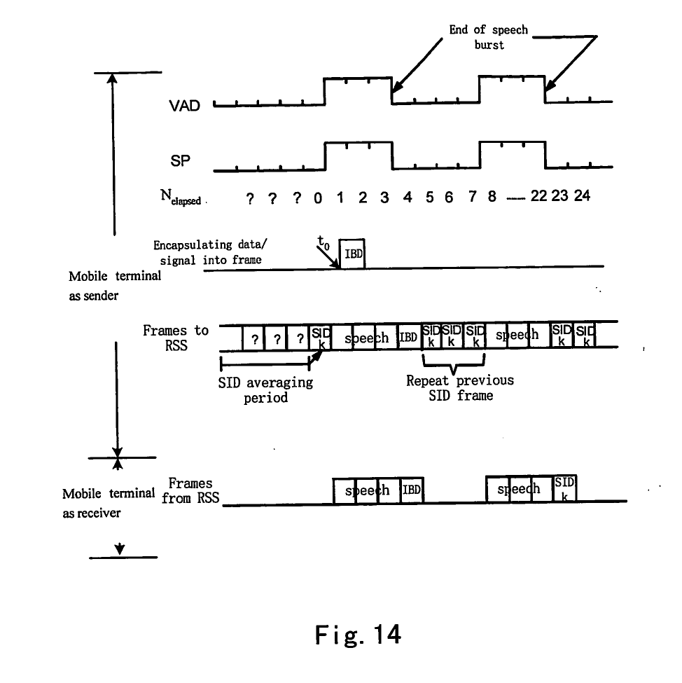

FIG. 14 illustrates an embodiment of the present invention, for transmitting the third type of IBD frames when the hangover procedure is not enabled. As displayed in the figure, the mobile terminal as sender sends out two speech bursts and the length of each speech burst is three speech frames.

With regard to the first speech burst, the VAD flag and SP flag are both 1 during the burst period, so Tx RSS 93 sends the three speech frames of the speech burst to the mobile terminal as receiver via the network system. When the speech burst is over, i.e. the VAD flag changes from 1 to 0, N_{elapsed}, the number of speech frames sent to Tx RSS 93 since the latest SID frame updates, is not greater than the threshold predefined by the hangover procedure, so Tx DTX control & operation unit 902 will not enable the hangover procedure and the SP flag is set to 0 meanwhile. At time t₀ during the first speech burst, upper-layer applications are required to encapsulate the data or signaling messages to be transmitted to the mobile terminal as receiver into a frame with respect to the third type of IBD frame and stores it in sending buffer 905, so Tx DTX control & operation unit 902 takes the IBD frame out and sends it to Tx RSS 93. The SID code word of zero value is included in the third type of IBD frame, thus Tx RSS 93 sends the IBD frame to the mobile terminal as receiver via the network system as a SID frame, then stops transmission and switches to idle state. In the mobile terminal as receiver, Rx RSS 96 receives three speech frames and an IBD frame sent by the mobile terminal as sender via the network system, and hands them to Rx DTX control & operation unit 1001. Rx DTX control & operation unit 1001 first sends the three received speech frames to speech decoder 1002 for decoding; then stores the received third type of IBD frame in receiving buffer 1005, and sets ReceiveIBDFlag to 1 to notify upper-layer applications about the arrival of IBD frames; and meanwhile sends a previously received SID frame to Rx comfort noise unit 1004 to generate background noise.

With regard to the second speech burst, the VAD flag and SP flag are both 1 during the burst period, so Tx RSS 93 sends the three speech frames of the speech burst to the mobile terminal as receiver directly. When the speech burst is over, i.e. the VAD flag changes from 1 to 0, N_{elapsed}, the number of speech frames sent to Tx RSS 93 since the latest SID frame updates, is not greater than the threshold predefined by the hangover procedure, thus Tx DTX control & operation unit 902 will not enable the hangover procedure and the SP flag is set to 0 meanwhile. Since sending buffer 905 is empty, Tx DTX control & operation unit 902 sends SID frames previously received to Tx RSS 93. After sending a received SID frame to the mobile terminal as receiver via the network system, Tx RSS 93 stops transmission and switches to idle state. In the mobile terminal as receiver, Rx RSS 96 receives three speech frames and a SID frame sent from the mobile terminal as sender via the network system, and then sends them to Rx DTX control & candle unit 1001. Rx DTX control & operation unit 1001 first sends the three received speech frames to speech decoder 1002 for decoding, and then sends the received SID frame to Rx comfort noise unit 1004 to generate background noise.

II. The Method for Transmitting Three Types of IBD Frames when the Hangover Procedure is Enabled

(I) The Method for Transmitting the First Type of IBD Frames via Voice Channel when the Hangover Procedure is Enabled

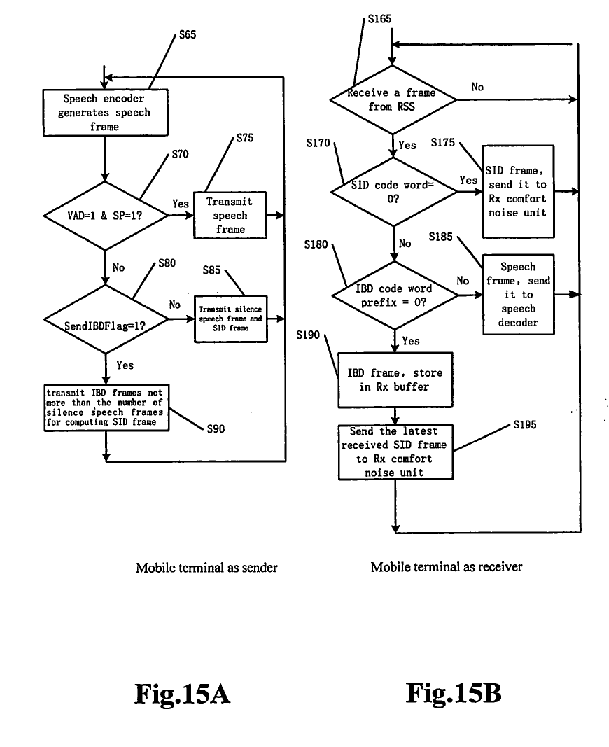

FIG. 15A and FIG. 15B are flow charts illustrating the transmission of the first type of IBD frames in accordance with the present invention when hangover procedure is enabled.

As displayed in the FIG. 15A, in the mobile terminal as sender, speech encoder 901 sends the generated speech frames to Tx DTX control & operation unit 902 (step S65). On receipt of the speech frames, Tx DTX control & operation unit 902 checks the state of the VAD flag (step S70).

1. If the VAD flag is 1, Tx DTX control & operation unit 902 sets the SP flag to 1 and sends the speech frames from speech encoder 901 to Tx RSS 93. Then, Tx RSS 93 sends the received speech frames to the mobile terminal as receiver via the network system (step S75).

2. If the VAD flag changes from 1 to 0, it means the speech burst is over. Is If the hangover procedure needs to be enabled at this moment (N_{elapsed}, the number of speech frames sent to Tx RSS 93 since the latest SID frame updates, is greater than the predefined threshold), Tx DTX control & operation unit 902 continues to set the SP flag to 1 and checks the state of SendIBDFlag (step S80).

(1) If SendIBDFlag is 0, it indicates sending buffer 905 is empty, thus Tx DTX control & operation unit 902 sends N (N is the number of silence speech frames for computing the SID frame) silence speech frames from speech encoder 901 to Tx RSS 93, then sets the SP flag to 0, and meanwhile sends the new SID frame generated according to the N silence speech frames to Tx RSS 93. After sending the received silence speech frames and a SID frame to the mobile terminal as receiver, Tx RSS 93 stops transmission and switches to idle state (step S85).

(2) If SendIBDFlag is 1, it indicates sending buffer 905 has IBD frames to be sent, then Tx DTX control & operation unit 902 sends IBD frames with the same number as the silence speech frames for computing the SID frame, to Tx RSS 93 (if the IBD frames are not enough, silence speech frames from speech encoder 901 will come as complement).

(a) If the VAD flag is still zero after said IBD frames are all sent out, Tx DTX control & operation unit 902 sets the SP flag to 0 and then sends a SID frame to Tx RSS 93, wherein the SID frame is computed according to the N silence speech frames. After sending the received IBD frames (or IBD frames and silence speech frames) and a SID frame to the mobile terminal as receiver via the network system, Tx RSS 93 stops transmission and switches to idle state.

(b) If the VAD flag changes to 1 when the IBD frames (or silence speech frames) are transmitted to Tx RSS 93, it indicates there is a new speech burst to be transferred, thus Tx DTX control & operation unit 902 stops sending IBD frames (or silence speech frames) but begins to send the speech frames of the new speech burst, to Tx RSS 93. Tx RSS 93 sends the received IBD frames (or IBD frames and silence speech frames) and the speech frames of the new speech burst to the mobile terminal as receiver. Since no SID frame is received, Tx RSS 93 will not stop transmission and switch to idle state (step S90).

As shown in FIG. 15B, in the mobile terminal as receiver, Rx RSS 96 checks whether it has received frames sent by the mobile terminal as sender via the network system. If any frame is received, it will be sent to Rx DTX control & operation unit 1001. On receipt of a frame from Rx RSS 96, Rx DTX control & operation unit 1001 checks whether the SID code word of the frame is zero (step S170).

1. If the SID code word equals to zero, it indicates the frame is a SID frame, then Rx DTX control & operation unit 1001 sends the SID frame to Rx comfort noise unit 1004 for processing, to generate background noise (step S175).

2. If the SID code word is not zero, Rx DTX control & operation unit 1001 checks whether the IBD code word prefix of the frame is zero (step S180). (1) If the IBD code word prefix is not zero, it indicates that the frame is a speech frame, then Rx DTX control & operation unit 1001 sends the speech frame to speech decoder 1002 to generate speech signals (step S185). (2) If IBD code word prefix is zero, it indicates that the frame is an IBD frame, then Rx DTX control & operation unit 1001 stores the IBD frame in receiving buffer 1005, and sets ReceiveIBDFlag to 1 to notify upper-layer applications that some IBD frames are received (step S190), and afterward sends one of the latest received SID frames to Rx comfort noise unit 1004 to generate background noise (step S195).

(II) The Method for Transmitting the Second Type of IBD Frames via Voice Channel when Hangover Procedure is Enabled

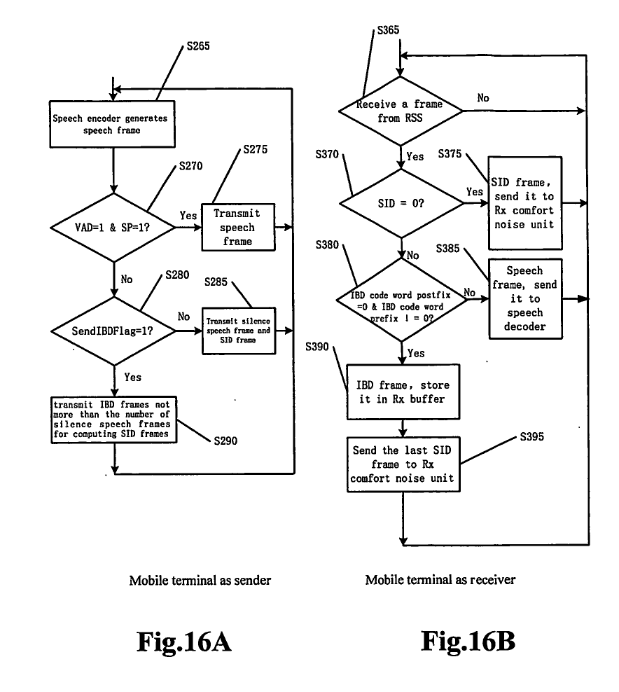

FIG. 16A and FIG. 16B illustrate the flow charts of transmitting the second type of IBD frames when hangover procedure is enabled.

As illustrated in FIG. 16A, in the mobile terminal as sender, speech encoder 901 generates speech frames and sends them to Tx DTX control & operation unit 902 (step S265). On receipt of t he speech frames from speech encoder 901, Tx DTX control & operation unit 902 checks the state of the VAD flag (step S270).

1. If the VAD flag is 1, Tx DTX control & operation unit 902 sets the SP flag to 1 and sends the speech frames from speech encoder 901 to Tx RSS 93. Then, Tx RSS 93 sends the received speech frames to the mobile terminal as receiver via the network system (step S275).

2. If the VAD flag changes from 1 to 0, it indicates the speech burst is over. If hangover procedure is required to be enabled (that is, N_{elapsed}, the number frames sent to Tx RSS 93 since the last SID frame updates, is greater than the threshold predefined by the hangover procedure), Tx DTX control & operation unit 902 enables the hangover procedure, continues to set the SP flag to be 1, and checks the state of SendIBDFlag (step S280).

(1) If SendIBDFlag is 0, i.e. sending buffer 905 is empty, Tx DTX control & operation unit 902 first sends N (N is the number of silence speech frames for computing the SID frame) silence speech frames from speech encoder 901 to Tx RSS 93, and then sets the SP flag to 0, and sends the new SID frame generated according to the N silence speech frames to Tx RSS 93. After sending the received silence speech frames and a SID frame to the mobile terminal as receiver, Tx RSS 93 stops transmission and switches to idle state (step S285).

(2) If SendIBDFlag is 1, i.e. there are IBD frames to be transmitted in sending buffer 905, Tx DTX control & operation unit 902 sends IBD frames with the same number as the silence speech frames for computing the SID frame, to Tx RSS 93 (if the IBD frames are not enough, silence speech frames from speech encoder 901 will come as complement).

(a) If the VAD flag is still zero after said IBD frames are all sent out, Tx DTX control & operation unit 902 sets the SP flag to 0, and then sends a SID frame to Tx RSS 93, wherein the SID frame is generated according to the N silence speech frames. After sending the received IBD frames (or IBD frames and silence speech frames) and a SID frame to the mobile terminal as receiver via the network system, Tx RSS 93 stops transmission and switches to idle state.

(b) If the VAD flag changes to 1 when IBD frames (or silence speech frames) are transmitted to Tx RSS 93, it indicates there is a new speech burst to be transferred. Tx DTX control & operation unit 902 stops sending IBD frames (or silence speech frames) but begins to send the speech frames of the new speech burst to Tx RSS 93. Tx RSS 93 sends the received IBD frames (or IBD frames and SID frames) and the speech frames of the new speech burst to the mobile terminal as receiver. Since no SID frame is sent, Tx RSS 93 will not stop transmission and switch to idle state (step S290).

As shown in FIG. 16B, in the mobile terminal as receiver, Rx RSS 96 checks whether it has received frames from the mobile terminal as sender via the network system (step S365). If any frame is received, it will be sent to Rx DTX control & operation unit 1001. On receipt of a frame from Rx RSS 96, Rx DTX control & operation unit 1001 checks whether the SID code word of the frame is zero (step S370).

1. If the SID code word is zero, it indicates the frame is a SID frame, then Rx DTX control & operation 1001 sends the SID frame to Rx comfort noise unit 1004 for processing, to generate background noise (step S375).

2. If the SID code word is not zero, Rx DTX control & operation unit 1001 checks the value of the IBD code word of the frame, i.e. the value of the IBD code word prefix and that of the IBD code word postfix in the frame (step S380).

(1) If the IBD code word prefix is not zero and the IBD code word postfix is zero, it indicates the frame is an IBD frame. Rx DTX control & operation unit 1001 stores the IBD frame in receiving buffer 1005, and sets ReceiveIBDFlag to 1 to notify upper-layer applications that some IBD frames are received (step S390), and then sends one of the latest received SID frames to Rx comfort noise unit 1004 to generate background noise (step S395).

(2) If the condition in (1) can't be satisfied, i.e. the condition can't be satisfied that the IBD code word prefix is not zero and the postfix is zero, it indicates the frame is a speech frame. Rx DTX control & operation unit 1001 sends the speech frame to speech decoder 1002 to generate speech signals (step S385).

(III) The Method for Transmitting the Third Type of IBD Frames via Voice Channel when Hangover Procedure is Enabled

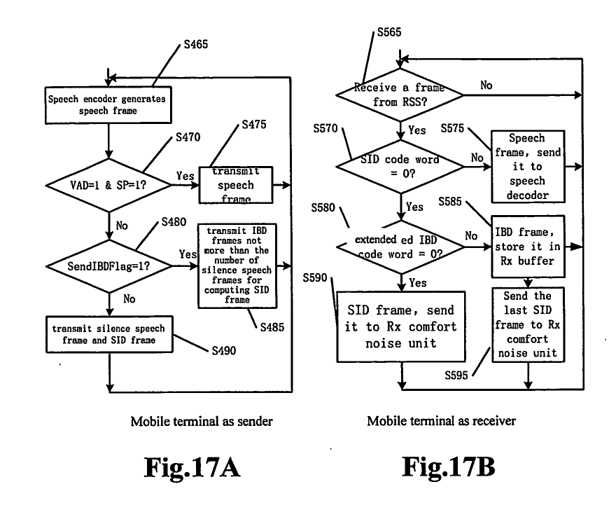

FIG. 17A and FIG. 17B are flow charts illustrating the transmission of the third type of IBD frames in the present invent ion when hangover procedure is enabled.

As shown in FIG. 17A, in the mobile terminal as sender, speech encoder 901 sends the generated speech frames to Tx DTX control & operation unit 902 (step S465). On receipt of the speech frames from speech encoder 901, Tx DTX control & operation unit 902 checks the state of the VAD flag (step S470).

1. If the VAD flag is 1, Tx DTX control & operation unit 902 sets the SP flag to 1 and sends the speech frames from speech encoder 901 to Tx RSS 93. Then, Tx RSS sends the received speech frames to the mobile terminal as receiver via the network system (step S475).

2. If the VAD flag changes from 1 to 0, it means the speech burst is over. If the hangover procedure is required to be enabled at this moment (that is, N_{elapsed}, the number of speech frames sent to Tx RSS 93 since the last SID frame updates, is greater than the threshold predefined by the hangover procedure), Tx DTX control & operation unit 902 continues to set the SP flag to 1 and checks the state of SendIBDFlag (step S480).

(1) If SendIBDFlag is zero, it indicates sending buffer 905 is empty. Tx DTX control & operation unit 902 first sends N (N is the number of silence speech frames for computing the SID frame) consecutive silence speech frames from speech encoder 901 to Tx RSS 93, then sets the SP flag to 0 and sends the new SID frame generated according to the N silence speech frames to Tx RSS 93. After sending the received silence speech frames and a SID frame to the mobile terminal as receiver via the network system, Tx RSS 93 stops transmission and switches to idle state (step S490).

(2) If SendIBDFlag is 1, it indicates sending buffer 905 has IBD frames to be transmitted, then Tx DTX control & operation unit 902 first sends IBD frames of not more than N, to Tx RSS 93 (if the IBD frames are not enough, silence speech frames from speech encoder 901 will come as complement).

(a) If the VAD flag is still zero after the IBD frames are all sent out, Tx DTX control & operation unit 902 sets the SP flag to 0 and then sends a SID frame to Tx RSS 93, wherein the SID frame is computed according to the N silence speech frames. After sending the received IBD frames (or IBD frames and silence speech frames) and a SID frame to the mobile terminal as receiver, Tx RSS 93 stops transmission and switches to idle state.

(b) If the VAD flag changes to 1 when the IBD frames (or silence speech frames) are transmitted, it indicates that there is a new speech burst to be transferred. Tx DTX control & operation unit 902 stops sending IBD frames (or silence speech frames) but begins to send the speech frames of the new speech burst to Tx RSS 93. Tx RSS 93 sends the received IBD frames (or IBD frames and silence speech frames) and the speech frames of the new speech burst to the mobile terminal as receiver. Since no SID frame is sent, Tx RSS 93 will not stop transmission and switch to idle state (step S485).

As FIG. 17B shows, in the mobile terminal as receiver, Rx RSS 96 checks whether it has receives frames from the mobile terminal as sender via the network system (step S565). If any frame is received, it will be sent to Rx DTX control & operation unit 1001. On receipt of a frame from Rx RSS 96, Rx DTX control & operation unit 1001 checks whether the SID code word of the frame is zero (step S570).

1. If the SID code word is not zero, it indicates the frame is a speech frame, then Rx DTX control & operation unit 1001 sends this speech frame to speech decoder 1002 for decoding (step S575).

2. If the SID code word is zero, Rx DTX control & operation unit 1001 checks whether the extended IBD code word of the frame is zero (step S580). (1) If the extended IBD code word is zero, it indicates the frame is a SID frame, then Rx DTX control & operation unit 1001 sends the SID frame to Rx comfort noise unit 1004 to generate background noise (step S590). (2) If the extended IBD code word is not zero, it indicates the frame is an IBD frame, thus Rx DTX control & operation unit 1001 stores the IBD frame into receiving buffer 1005, and sets ReceiveIBDFlag to 1 to notify upper-layer applications that some IBD frames are received (step S585), and then sends one of the latest received SID frames to Rx comfort noise unit 1004 to generate background noise (step S595).

Similar to the above cases when the hangover procedure is not enabled as illustrated in FIG. 10A and FIG. 10B, FIG. 11A and FIG. 11B, FIG. 12A and FIG. 12B, the flow charts in FIG. 15A and FIG. 15B, FIG. 16A and FIG. 16B, FIG. 17A and FIG. 17B elaborate the transmission of the three types of IBD frames when hangover procedure is enabled. The main differences between them can be summarized as: (1) In the upper-layer applications of the mobile terminal as sender, the functional blocks for forming the three types of IBD frames are different. Except this, other functional blocks for transferring the three types of IBD frames are the same. (2) In the Rx DTX control & operation unit of the mobile terminal as receiver, the functional blocks for identifying the three types of IBD frames are different, and correspondingly the functional blocks in upper-layer applications for decoding the three types of IBD frames should be of some difference too. Except this, in the mobile terminal as receiver, other functional blocks for processing the three types of IBD frames are the same.

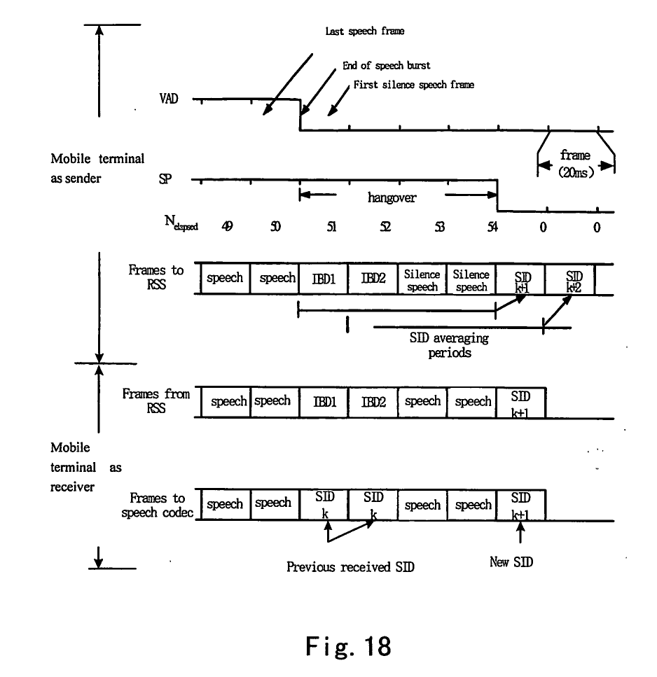

FIG. 18 illustrates an embodiment of the proposed method for transmitting the first type of IBD frames, and the procedure as shown in the figure is equally applicable to the second and third types of IBD frames.

As the figure displays, in the mobile terminal as sender, the VAD flag and SP flag are both 1 during the burst period, so Tx RSS 93 sends the speech frames of the speech burst to the mobile terminal as receiver via the network system. When the speech burst is over, i.e. the VAD flag changes to 0, N_{elapsed}, the number of speech frames sent to Tx RSS 93 since the latest SID frame updates, is greater than the threshold predefined by the hangover procedure, so Tx DTX control & operation unit 902 will enable the hangover procedure and continues to set the SP flag to 1 meanwhile. Since there are only two IBD frames, IBD1 and IBD2 in sending buffer 905, Tx DTX control & 10 operation unit 902 sends IBD1 and IBD2 and two silence speech frames from speech encoder 901 to Tx RSS 93. When the four frames are all sent out, the VAD flag is still zero, thus Tx DTX control & operation unit 902 sets the SP flag to 0, and then sends SID frames (e.g. SIDₖ₊₁ and SIDₖ₊₂ in the figure) to Tx RSS 93. After sending the speech frames of the speech burst, IBD1, IBD2, two silence speech frames and SIDₖ₊₁ received to the mobile terminal as receiver via the network system, Tx RSS 93 stops transmission and switches into idle state.

At the mobile terminal as receiver, Rx RSS 96 receives the speech frames of the speech burst, IBD1, IBD2, two silence speech frames, and SIDₖ₊₁ from the mobile terminal as sender via the network system, and then sends them to Rx DTX control & operation unit 1001. Rx DTX control & operation unit 1001 first sends the received speech frames in receiving order, to speech decoder 1002 for decoding; then stores IBD1 and IBD2 into receiving buffer 1005, and sets ReceiveIBDFlag to 1 to notify upper-layer applications that some IBD frames are received; afterward sends two previously received SID frames (e.g. SIDₖ in the figure) to Rx comfort noise unit 1004; next sends the two received silence speech frames to speech decoder 1002 for decoding; and finally sends SIDₖ₊₁ to Rx comfort noise unit 1004 to generate background noise.

The above section describes the procedure for transferring IBD frames via voice channel between two mobile terminals both supporting IBD frames in GSM full-rate speech traffic, in conjunction with FIG. 10A to FIG. 18. In the following section, an embodiment will go to a mobile terminal supporting IBD frames and another mobile terminal not supporting IBD frames, to describe the transmission of IBD frames between them.

It's assumed that mobile terminal MS1 supports IBD frames while mobile terminal MS2 doesn't. If MS2 receives a frame with respect to the first type of IBD frames from MS1, it will regard the IBD frame as a speech frame and send it directly to the speech decoder for decoding because the SID code word of the first type of IBD frame is not zero. If the speech decoder generates false speech signals by using this IBD frame, the listener may feel very uncomfortable, because the false speech signal might contain very high energy and mismatch with the speech signals generated from other normal speech frames.

If MS2 receives a frame with respect to the second type of IBD frame from MS1, it will also regard the IBD frame as a speech frame and send it directly to the speech decoder for decoding to generate false speech signals because the SID code word in the IBD frame is not zero. Fortunately, the 24 bits for Block Amplitude parameter are defined as the IBD code word postfix in the second type of IBD frame and all the 24 bits are set to zero, so the speech signal generated according to Block Amplitude parameter of the second type of IBD frame has very low energy. Even if the false speech signal mismatches with normal speech frames, no significant impact will occur on the listener.

If MS2 receives a frame with respect to the third type of IBD frame from MS1, MS2 will store this IBD frame as a new SID frame and generate background noise using this IBD frame because the SID code word of the third type of IBD frame is zero. The third type of IBD frame is not a true SID frame, and thus no background noise parameters are included, so the generated noise is false background noise and will only impose uncomfortableness to human hearing in some certain period (for example, 20 ms in GSM/GPRS).

As stated in the above analysis, the first and third types of IBD frame will produce significant influence upon mobile terminals that don't support IBD frames, whereas the second type of IBD frame doesn't have much impact on mobile terminals that don't support IBD frames.

Two solutions are provided in the present invention, to eliminate the negative effects of IBD frames on mobile terminals that don't support IBD frames.

Solution 1: IBD frame should carefully use the bits for various parameters in the speech frame. For example, if the 24 bits for Block Amplitude parameter are set to zero or very low value in the first and third types of IBD frames, the IBD frame will have very low energy, and thus won't cause uncomfortableness to the listener.

Solution 2: A new communication protocol should be defined. In this new protocol, a mobile terminal first send s a probing frame (the probing frame can be of very low energy by setting each bit to appropriate value) to another mobile terminal before sending IBD frames, to check whether said another mobile terminal supports IBD frames. If said another mobile terminal supports IBD frame, it will sends back a probing response in return to said mobile terminal after receiving the probing frame; otherwise, it just ignores the received probing frame. If the mobile terminal sending the probing frame receives a probing response from said another mobile terminal, IBD frames can be used during communication procedure; otherwise, IBD frames cannot be used during communication procedure.

In the embodiments of the present invention, GSM full-rate speech traffic is taken as a example, to describe the methods for transferring the first, second and third types of IBD frames via voice channel when the hangover procedure is enabled and when the hangover procedure is not enabled. This methods can be implemented in software or in hardware. Furthermore, the principle and implementation procedure can equally extend to other GSM speech traffics.

Beneficial Results of the Invention

As described above, with regard to the method and apparatus for transmitting non-speech data via voice channel in the present invention, silence speech frames and SID frames are utilized to transmit IBD frames via voice channel, thus the system resources can be saved a lot. Furthermore, from FIG. 9 and its explanation thereof, we can also draw a conclusion that little modifications need to be made to current mobile terminals (The sending/receiving buffer in the present invention just expands the original buffer of current systems, and the added data interface is also very simple. In fact, the biggest change occurs in the scheduling and classifying algorithms in the DTX control & operation unit, but this is just a modification in software, by improving the original algorithm for classifying two types of frames in to a modified algorithm capable of classifying/scheduling three types of frames. This can be implemented in software or in hardware, and won't bring significant and difficult modifications to current systems). Additionally, the proposed method can eliminate the negative effects of transmitting IBD frames upon mobile terminals not supporting IBD frames, through lowering the value of the bits for carrying background noise information in the IBD frame or sending probing frame.

It is to be understood by those skilled in the art that the method and apparatus for transmitting non-speech data in voice channel as disclosed in the present invention can be modified considerably without departing from the spirit and scope of the invention as defined by the appended claims.

1. A method for a mobile terminal in mobile communication systems to transfer non-speech data over voice channel, comprising steps of:
(a) detecting whether the speech burst sent to another mobile terminal is over;
(b) checking whether there is non-speech data to be sent to said another mobile terminal if detecting that the speech burst is over;
(c) sending at least one non-speech data to said another mobile terminal via voice channel if there is non-speech data to be sent.

2. The method as claim 1, wherein before step (a), further including steps of:
(i) encapsulating said non-speech data to be sent to said another mobile terminal into IBD (In-Band Data) frames;
(ii) storing the IBD frames in a buffer.

3. The method as claim 2, wherein the IBD code word for marking said IBD frames is composed of the SID (Silence Description) code word for marking a SID frame, and the value of each bit selected from the bits that form the SID code word, for differentiating the IBD code word from the SID code word, can't be the same as that of each bit for marking the SID code word.

4. The method as claim 3, wherein the number of said selected bits is required to ensure that the value of each bit forming said IBD code word will not appear in speech frames.

5. The method as claim 2, wherein the IBD code word for marking said IBD frames is composed of all bits for carrying Block Amplitude parameter and at least one bit selected from the SID code word for marking said a SID frame, and the value of each said bit for carrying Block Amplitude parameter is zero, and the value of each said bit selected from the SID code word can't be the same as that of each bit for marking the SID code word.

6. The method as claim 2, wherein the IBD code word for marking said IBD frames is composed of the SID code word for marking a SID frame and at least one reserved bit not included in the SID code word.

7. The method of claim 3, wherein said IBD frames have the same length as said SID frame and the speech frames sent from the mobile terminal to said another mobile terminal.

8. The method as claim 7, wherein said IBD frames are sent during the time when said SID frame is supposed to be sent in conventional communications if hangover procedure is not enabled.

9. The method as claim 7, wherein if hangover procedure is enabled, said IBD frames are sent during the time when the silence speech frames are supposed to be sent in conventional communications, wherein said silence speech frames are used to compute said SID frame.

10. The method of claim 3, further comprising steps of:
(d) pausing sending said IBD frames if detecting that a new speech burst is required to transfer to said another mobile terminal while said IBD frames have not all been sent out yet; and
(e) sending the new speech burst to said another mobile terminal.

11. The method of claim 3, wherein the value of the bits for carrying Block Amplitude parameter in said IBD frames is set to zero or nearly zero.

12. The method as claim 1, before executing step (c), further comprising steps of:
sending a probing frame to said another mobile terminal to check whether said another mobile terminal supports IBD frames; and
sending IBD frames to said another mobile terminal if receiving the confirmation response from said another mobile terminal.

13. A method for a mobile terminal to transfer non-speech data in voice channel, comprising steps of:
(i) detecting the received frame from another mobile terminal;
(ii) storing, if the received frame is a IBD (In-Band Data) frame, the IBD frame;
(iii) generating background noise by using the previously received SID frame.

14. The method as claim 13, wherein the IBD code word for marking said IBD frames is composed of the SID (Silence Description) code word for marking a SID frame, and the value of each bit selected from the bits that form the SID code word, for differentiating the IBD code word from the SID code word, can't be the same as that of each bit for marking the SID code word.

15. The method as claim 13, wherein the IBD code word for marking said IBD frames is composed of all bits for carrying Block Amplitude parameter and at least one bit selected from the SID code word for marking a SID frame, and the value of each said bit for carrying Block Amplitude parameter is zero, and the value of each said bit selected from the SID code word can't be the same as that of each bit for marking the SID code word.

16. The method as claim 13, wherein the IBD code word for marking said IBD frames is composed of the SID code word for marking a SID frame and at least one reserved bit not included in the SID code word.

17. The method of claim 14, wherein said IBD frames have the same length as said SID frame and the speech frames from said another mobile terminal.

18. The method as claim 14, wherein step (i) further includes:
(a1) checking the SID code word of said received frame;
(a2) detecting the value of the remained bits after said bits are selected from the SID code word to judge whether said received frame is an IBD frame, if the SID code word indicates that said received frame is not a SID frame.

19. The method as claim 15, wherein step (i) further includes:
(a2) checking the SID code word of said received frame;
(b2) detecting the value of all bits for carrying Block Amplitude parameter and the value of said bits selected from the SID code word, to judge whether said received frame is an IBD frame, if the SID code word indicates that said received frame is not a SID frame.

20. The method as claim 16, wherein step (i) further includes:
(a3) checking the SID code word of said received frame;
(b3) detecting the value of said reserved bits not included in the SID code word, to judge whether said received frame is an IBD frame, if the SID code word indicates that said received frame is not a speech frame.

21. The method of claim 14, wherein the value of the bits for carrying Block Amplitude parameter in said IBD frames is set to zero or nearly zero.

22. The method of claim 18, wherein further comprising steps of:
(c) receiving a probing frame from said another mobile terminal;
(d) returning a confirmation response to said another mobile terminal if the mobile terminal supports IBD frames.

23. A mobile terminal, comprising:
the first detecting unit, for detecting whether a speech burst sent from the mobile terminal to another mobile terminal is over, and checking whether there is non-speech data to be sent to said another mobile terminal when detecting that the speech burst is over;
a sending unit, for sending frames to said another mobile terminal;
a control unit, for controlling said sending unit to send at least one non-speech data frame to said another mobile terminal via voice channel when there is non-speech data to be sent.

24. The mobile terminal in claim 23, further comprising:
an IBD (In-Band Data) frame generating unit, for encapsulating the non-speech data to be sent to said another mobile terminal into IBD frames;
the first buffer, for storing the generated IBD frames.

25. The mobile terminal in claim 24, wherein the IBD code word for marking said IBD frames is composed of the SID code word for marking a SID frame, and the value of each bit selected from the bits that form the SID code word, for differentiating said IBD code word from said SID code word, can't be the same as that of each bit for marking the SID code word.

26. The mobile terminal in claim 24, wherein the IBD code word for marking said IBD frames is composed of all bits for carrying Block Amplitude parameter and at least one bit selected from the SID code word for marking a SID frame, and the value of each said bit for carrying Block Amplitude parameter is zero, and the value of each said bit selected from the SID code word can't be the same as that of each bit for marking the SID code word.

27. The mobile terminal in claim 24, wherein the IBD code word for marking said IBD frames is composed of the SID code word for marking a SID frame and at least one reserved bit not included in the SID code word.

28. The mobile terminal in claim 25, wherein said IBD frames have the same length as said SID frame and the speech frames sent from the mobile terminal to said another mobile terminal.

29. The mobile terminal in claim 28, wherein if the hangover procedure is not enabled, said sending unit sends said IBD frames during the time when said SID frame is supposed to be sent in conventional communications.

30. The mobile terminal in claim 28, wherein if the hangover procedure is enabled, said sending unit sends said IBD frames during the time when the silence speech frames are supposed to be sent in conventional communications, wherein said silence speech frames are used to compute said SID frame.

31. The mobile terminal in claim 28, further comprising:
the second detecting unit, for detecting a frame received from said another mobile terminal;
the second buffer, for when the received frame is a IBD frame, buffering the IBD frame;
a Rx comfort noise unit, for generating background noise by using the previously received SID frames.

32. The mobile terminal in claim 31, wherein said detecting unit further comprising:
an IBD frame identifying unit, for checking the SID code word of said received frame, and detecting the value of the remained bits after said bits are selected from said SID code word to judge whether said received frame is an IBD frame when said SID code word indicates that said received frame is not a SID frame.

33. The mobile terminal in claim 31, wherein said detecting unit further comprising:
an IBD frame identifying unit, for checking the SID code word of said received frame, and detecting the value of all bits for carrying Block Amplitude parameter and the value of said bits selected from said SID code word to judge whether said received frame is an IBD frame when said SID code word indicates that said received frame is not a SID frame.

34. The mobile terminal in claim 31, wherein said detecting unit further comprising:
an IBD frame identifying unit, for checking the SID code word of said received frame, and checking the value of said reserved bits not included in said SID code word to judge whether said received frame is an IBD frame when said SID code word indicates that said received frame is not a speech frame.
